(19) United States
(12) Patent Application Publication
(10) Pub. No.: US 2005/0129492 A1
(43) Pub. Date: Jun. 16, 2005

(54) Rear Cargo Pivot Platform

(76) Inventor: John S. McKenzie, Royal Oak, MI (US)

Correspondence Address: Bruce E. Harang, PO BOX 872735, VANCOUVER, WA, 98687-2735, US

(21) Appl. No.: 10/707,410

(22) Filed: Dec. 11, 2003

(51) Int. Cl. B60P 1/00

(52) U.S. Cl. 414/522

(57) ABSTRACT

Disclosed is a cargo storage platform for use in the rear cargo area of a vehicle which pivots from a storage position to a loading/unloading position on a pivot joint located at one corner of said cargo storage platform base.

### BACKGROUND OF INVENTION

1. Field of the Invention

The present invention generally relates to a moveable cargo platform or floor which is moveably mounted in the cargo area of a vehicle such as a station wagon or an SUV. More particularly the present invention relates to a moveable cargo platform that moves on a single pivot requiring only one mounting point within a vehicle.

2. Description of the Related Art

Providing an easy safe means of accessing cargo placement and removal from a vehicle has been an increasing concern with the growing popularity of vehicles having large cargo areas such as SUVs. The prevailing manner of providing this means of access to cargo has been a track or frame mounted slidable table requiring the permanent or removable mounting of at least a pair of tracks to the floor of the vehicle.

For example, U.S. Pat. No. 5,046,913 issued Sep. 10, 1991 to Domek et al teaches removably mountable sliding table for use in the cargo area of a vehicle utilizing a pair of removably mountable tracks to which a table is slidably mounted.

U.S. Pat. No. 5,052,878 issued Oct. 1, 1991 to Brockhaus teaches slidable bed for a truck using a pair of tracks upon which the slidable bed travels.

U.S. Pat. No. 5,513,941 issued May 7, 1996 to Kulas et al teaches another slidable table mounted on a track system adaptable for use in various vehicles.

### DISCLOSURE OF THE INVENTION

The present invention provides advantages and alternatives over the prior art by providing a cargo accessing moveable platform which does not require the use of a track system to provide the necessary movement of the platform.

According to a further aspect of the present invention, pivot mounted moveable cargo platform for use in vehicles such as station wagons and SUVs for example.

According to yet another aspect of the present invention there is provided a pivoting cargo platform, for use in the cargo area of a vehicle, in cooperative combination comprising: a cargo platform base having a substantially rectangular shape having four corners; and a pivoting joint mounted at one corner of said cargo platform base and said pivoting joint capable of also being mounted to a vehicle cargo area floor; thereby providing a cargo platform that pivots from a storage position to a loading/unloading position.

The present invention thus advantageously provides a user accessible storage platform that allows access without having to lean into the cargo compartment while at the same time allowing the platform to be rotated out of the way when not in use and when cargo is stored upon it.

### BRIEF DESCRIPTION OF DRAWINGS

FIG. 1 shows a perspective view of the present invention mounted in the cargo area of a vehicle in the storage position.

FIG. 2 shows a perspective view of the present invention mounted in the cargo area of a vehicle being moved into the cargo loading/unloading position.

FIG. 3 shows a perspective view of the present invention mounted in the cargo area of a vehicle in the cargo loading/unloading position.

FIG. 4 show a perspective detail view of the pivot end section of the present invention mounted in the cargo area of a vehicle.

FIG. 5 shows a perspective view of the non-pivot end section of the present invention showing a platform support and a pull strap.

### DETAILED DESCRIPTION

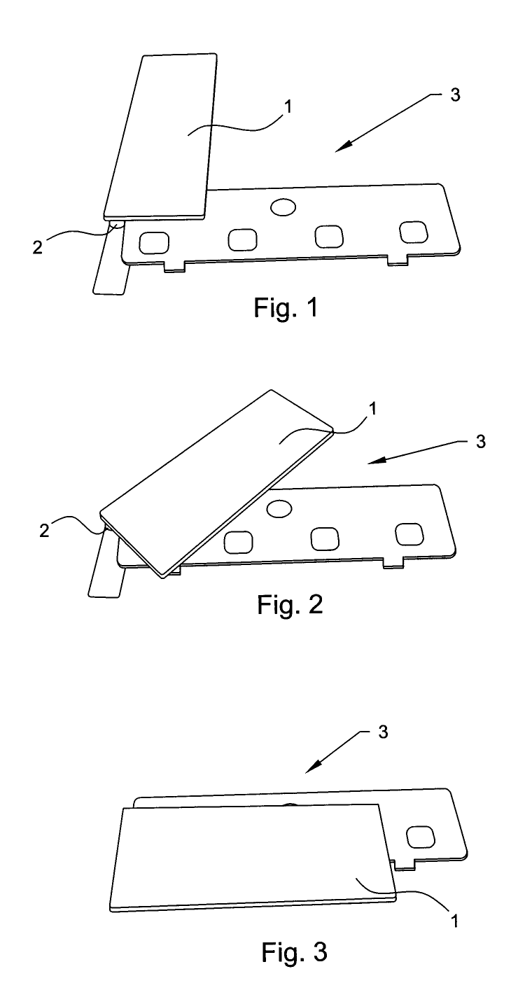

Reference will now be made to the drawings, wherein to the extent possible like reference numerals are utilized to designate like components throughout the various views. Referring to FIG. 1, which presents a perspective view of the present invention mounted to the floor of the cargo area 3 of a vehicle having a cargo platform base 1 in a storage position mounted at one corner by way of pivot joint 2.

Referring now to FIG. 2, there is shown the cargo platform base 1 mounted at one corner by way of pivot joint 2 to the floor 3 of the cargo area of a vehicle as it is being moved from the storage position to the cargo loading/unloading position.

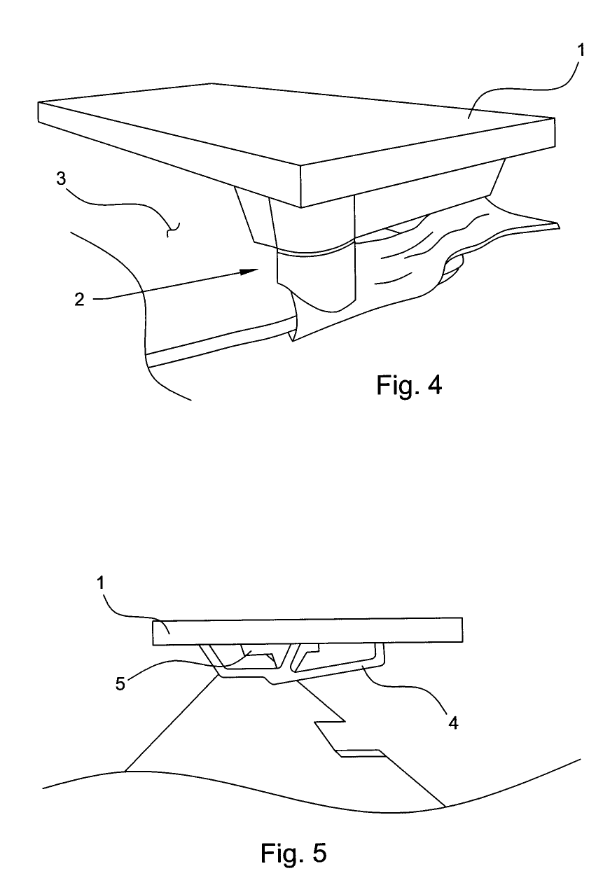

FIG. 3 shows the vehicle cargo area floor 3 with cargo platform base 1 in the cargo loading/unloading position.

Turning now to FIG. 4, there is shown a close-up view of the pivot joint 2 attached to one corner of cargo platform base 1 and to the cargo area floor 3.

In FIG. 5 is shown the end of cargo platform base 1 not having the pivot mount 2 and showing a platform support 4 and a cargo platform pull strap 5 both attached to the cargo platform base 1.

One particularly preferred embodiment of the present invention provides for a platform support 4 which may be folded into position when the cargo platform base 1 is in use and folded up out of position when said cargo platform base 1 is not being used to storage cargo.

It is to be understood that the pivot joint 2 may be either mounted permanently or removably to the cargo area floor 3 or the pivot joint 2 may be clamped underneath storage doors (not shown) in rear cargo area of a vehicle.

The presently preferred clamp is a C-type clamp assembly having a screw-type clamp securing mechanism to removably secure the cargo platform to a removable cargo floor panel.

The cargo platform base 1 and the pivot joint 2 may be composed of the same or different materials. In addition, the portion of the pivot joint 2 mounted on cargo platform base 1 may be molded as an integral part of said cargo platform base 1. The presently preferred materials for construction of the cargo platform base 1 and the pivot joint 2 are plastics capable of vacuum forming or injection molding.

The pivot joint 2 may be of any known design as is well known in the art, particularly preferred is a joint comprising a pin mounting bracket on attached to the cargo platform base 1 and another pin mounting bracket attached to the cargo area floor 3 connected by a pin joining both of said pin mounting brackets thus creating a rotational pivot. Preferably the pin is made of metal and the pin mounting brackets are made of plastic.

Although the preferred embodiments of the present invention has been disclosed, various changes and modifications may be made without departing from the scope of the invention as set forth in the appended claims.

1. A pivoting cargo platform, for use in the cargo area of a vehicle, in cooperative combination comprising: a cargo platform base having a substantially rectangular shape having four corners; and a pivoting joint mounted at one corner of said cargo platform base and said pivoting joint capable of also being mounted to a vehicle cargo area floor; thereby providing a cargo platform that pivots from a storage position to a loading/unloading position.

2. The invention as claimed in claim 1 wherein, said cargo platform base has a platform support member mounted opposite said pivoting joint.

3. The invention as claimed in claim 1 wherein, said cargo platform base has a pull strap mounted opposite said pivoting joint.

4. The invention as claimed in claim 2 wherein, said cargo platform base has a pull strap mounted opposite said pivoting joint.

5. The invention as claimed in claim 1 wherein, said cargo platform base and said pivoting joint are composed of a plastic capable of vacuum forming.

6. The invention as claimed in claim 1 wherein, said cargo platform base and said pivoting joint are composed of a plastic capable of injection molding.

7. The invention as claimed in claim 1 wherein, said pivoting joint portion mounted on said cargo platform base is molded as an integral part of said cargo platform base.

8. The invention as claimed in claim 1 wherein, said pivoting joint comprises a pair of plastic pivot mounting brackets joined together by a metal pivot pin.

9. The invention as claimed in claim 1 wherein, said pivoting cargo platform is permanently mounted to said vehicle cargo area.

10. The invention as claimed in claim 1 wherein, said pivoting cargo platform is removably mounted to said vehicle cargo area.

11. The invention as claimed in claim 10 wherein, said pivoting cargo platform is removably mounted to a removable floor panel.

12. The invention as claimed in claim 10 wherein, said removable mounting being accomplished using a C-type clamp having a screw-type tightening mechanism.
